(19) United States
(12) Patent Application Publication
(10) Pub. No.: US 2008/0310677 A1
(43) Pub. Date: Dec. 18, 2008

(54) OBJECT DETECTION SYSTEM AND METHOD INCORPORATING BACKGROUND CLUTTER REMOVAL

(76) Inventors: Thomas P. Weismuller, Orange, CA (US); David L. Caballero, Huntington Beach, CA (US)

Correspondence Address: HARNESS DICKEY & PIERCE, PLC, P.O. BOX 828, BLOOMFIELD HILLS, MI, 48303, US

(21) Appl. No.: 11/764,396

(22) Filed: Jun. 18, 2007

(51) Int. Cl. G06K 9/00

(52) U.S. Cl. 382/103

(57) ABSTRACT

A method and system for optically detecting an object within a field of view where detection is difficult because of background clutter within the field of view that obscures the object. A camera is panned with movement of the object to motion stabilize the object against the background clutter while taking a plurality of image frames of the object. A frame-by-frame analysis is performed to determine variances in the intensity of each pixel, over time, from the collected frames. From this analysis a variance image is constructed that includes an intensity variance value for each pixel. Pixels representing background clutter will typically vary considerably in intensity from frame to frame, while pixels making up the object will vary little or not at all. A binary threshold test is then applied to each variance value and the results are used to construct a final image. The final image may be a black and white image that clearly shows the object as a silhouette.

### CROSS-REFERENCE TO RELATED APPLICATIONS

This application is related in general subject matter to U.S. Pat. No. 6,954,551 to Weismuller, issued Oct. 11, 2005. This patent is hereby incorporated by reference into the present application.

### FIELD

The present disclosure relates to systems and methods for optically tracking and detecting objects within a predetermined field of view, and more particularly to a system and method for optically detecting objects that is also able to determine background clutter in an image in which the object is present, to identify the background clutter, and to construct an image of the object being tracked without the background clutter.

### BACKGROUND

The statements in this section merely provide background information related to the present disclosure and may not constitute prior art.

Tracking of objects using visual imagery is important to a wide variety of applications including surveillance, weapons targeting, docking and many others. These objects can include ground vehicles, aircraft, satellites, humans or virtually anything else that moves across the visual field. Scene input can be provided from visual sensors, infrared cameras or other imaging devices. In any case, a discriminator must be found to distinguish the object of interest from the background in the imagery. Usually this involves computing a pixel threshold value which will effectively separate the object and background pixels. In some cases, this is an easy task, such as when tracking a brightly lit aircraft across a dark night sky. In this example, it is relatively easy to find some pixel intensity threshold below which almost everything is background (dark night sky), and above which almost everything belongs to the aircraft being tracked. The problem is equally easy to address, but reversed, if the aircraft is very dark, but the background is a bright day sky. In this case, the threshold divides dark pixels belonging to the aircraft from bright pixels belonging to the sky.

However, in many applications the background may be very similar in intensity to the object of interest. Alternatively, the background may have regions that lie both above and below that of the object, in terms of pixel intensity. To complicate matters, the object itself may have variable intensity. An example of a highly cluttered background is shown in FIG. 1, which shows a Cessna 172 aircraft as seen from above, flying over an urban landscape. From this scene it is not possible to select a suitable threshold which is able to distinguish the aircraft from the background based on pixel intensity. An attempt to do this is shown in FIG. 2. Here, some success in isolating the wings is achieved (black wings against a white background), but overall the results are poor. Many areas of clutter are included as detections (dark areas) along with the aircraft itself. These results would not be acceptable for optical tracking purposes. Previous attempts to improve separation have included using different types of camera input, such as infrared sensors. This can be an effective solution but is not always practical, nor is it guaranteed to eliminate the clutter problem.

### SUMMARY

The present disclosure relates to a method and system for optically detecting an object from within a field of view, where the field of view includes background clutter that tends to obscure optical visualization of the object. In one implementation the method includes optically tracking an object such that the object is motion stabilized against the background clutter present within the field of view. During the optical tracking, a plurality of frames of the field of view is obtained. The plurality of frames is used in performing a frame-to-frame analysis of variances in intensities of pixels, over time, in the frames. Typically the intensities of pixels of background clutter will vary significantly over time, while the intensities of pixels making up the object will vary only a small degree in intensity. The variances in intensities are used to discern the object.

In one specific implementation the frame-to-frame analysis of variances in intensities of pixels involves using the variances in intensities of the pixels to construct an intensity variance image. Each pixel of the intensity variance image is compared to a predetermined threshold intensity value. The results of the comparisons of each pixel to the threshold intensity value are used to construct a final image of the object.

In one specific embodiment of the system a camera is used to obtain the plurality of frames of the field of view over a predetermined time period. The camera is panned to track movement of the object so that the object is image stabilized against the background clutter. A processor is used to perform the frame-to-frame analysis of the variance of each pixel, to construct the intensity variance image, and to perform a threshold comparison for each pixel of the intensity variance image against a predetermined intensity threshold value. The threshold comparisons are then used to construct the final image, which in one example is a black and white image of the object being detected. A display may be used to display the final image.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a prior art aerial view of an image in which a small aircraft is present (noted by an arrow), illustrating the difficulty in discerning the aircraft from a large degree of background clutter formed by pixels having intensities similar to those pixels that are forming the aircraft;

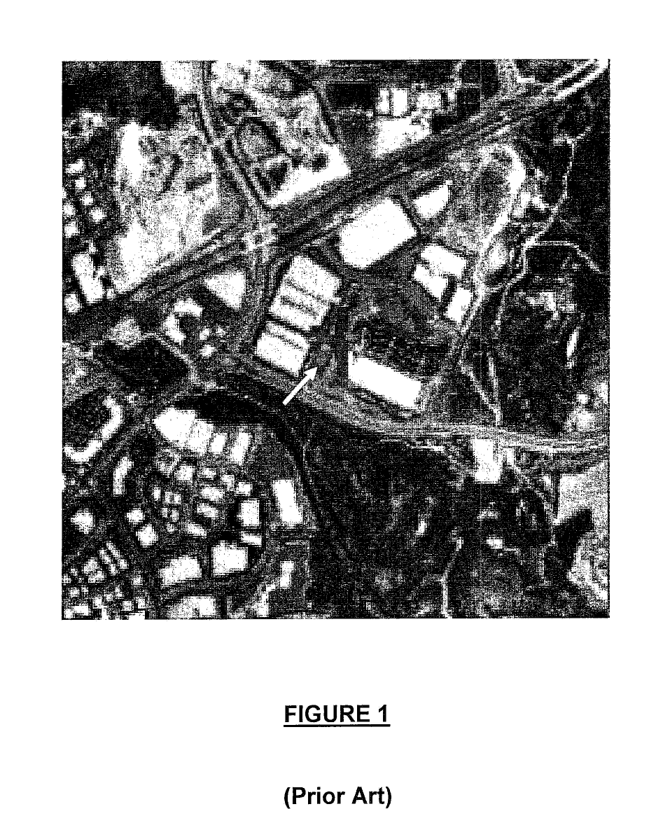

FIG. 2 is a prior art image illustrating an attempt to threshold the aircraft (denoted again by an arrow) in FIG. 1 against the background clutter;

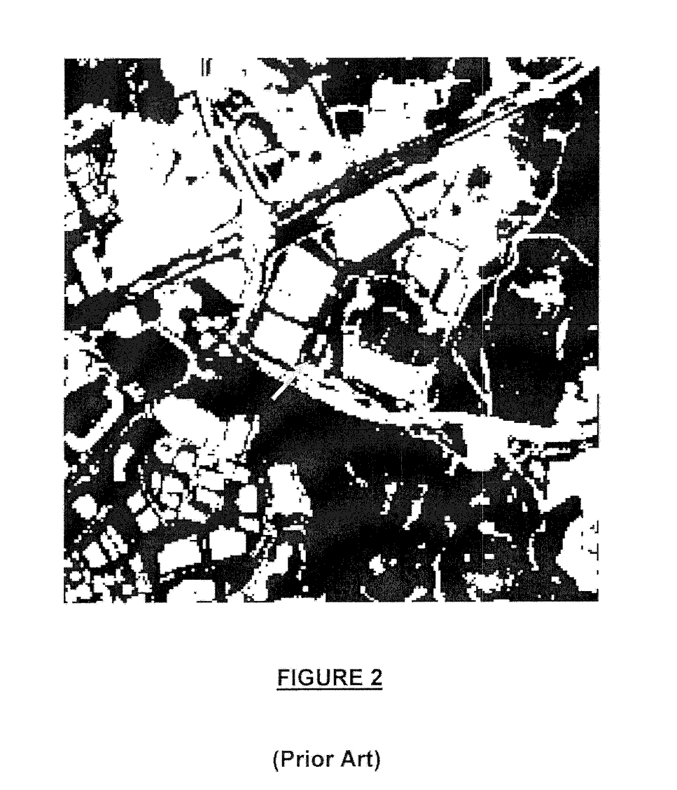

FIG. 3 is a block diagram of a system in accordance with one embodiment of the present disclosure;

FIG. 4 is a flowchart of a method in accordance with one implementation of the present disclosure for creating a new image based on variances in intensities of pixels in a series of image frames of the object, taken over a predetermined time; and

FIG. 5 is an image of the aircraft of FIG. 1 produced in accordance with the system and method of the present disclosure.

### DETAILED DESCRIPTION

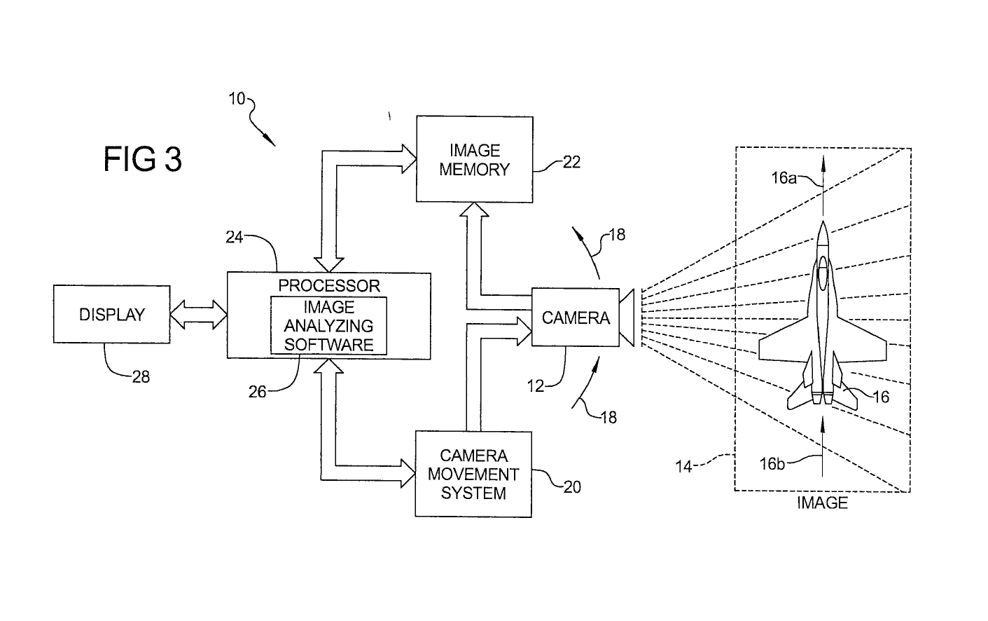

Referring to FIG. 3, a system 10 is shown in accordance with one exemplary embodiment of the present disclosure. The system 10 may generally include a camera 12 for obtaining a plurality of frames of a field of view 14. The field of view 14 will be understood to typically contain at least some, or possibly a large degree of, background clutter that tends to make optically discerning an object 16 within the field of view 14 difficult. By “discerning” it is meant optically detecting the object with sufficient certainty to deduce that the object is a specific type of object (e.g., F-14 military jet aircraft). However, it will be appreciated the system 10 can be used to detect virtually any type of moving, or even nearly stationary, object, and is therefore not limited to only detecting aircraft or rapidly moving objects.

The camera is panned, as indicated by arrows 18, with the object 16 so that the object is image stabilized relative to the background clutter within the field of view 14. In this example the object is traveling in the direction indicated by arrows 16a. A suitable camera movement subsystem 20, for example containing one or more stepper motors, may be used to control X, Y and/or Z axis movement of the camera 12 as needed to track the object 16. Alternatively, the camera 12 may be manually controlled.

The camera 12 takes a plurality of image frames of the field of view 14 over a predetermined period of time. The frames may be stored in a non-volatile image memory 22 that effectively forms a “running” buffer. By “running” buffer, it is meant a buffer that maintains a predetermined number of frames (e.g., 20 frames) in storage and continually drops off the oldest stored frame as each new frame is stored. The predetermined time period may vary depending upon the type of object being tracked and other factors, For example, the time period may comprise less than one second to several minutes. Typically at least about 10-1000 frames may be obtained although, again, the precise number of frames needed may vary significantly depending upon a number of variables. Such variables may include the type of object being tracked and the type of background environment (e.g., clear sky, aerial view of urban environment, etc., rain or other atmospheric conditions being present, speed of the object, size of the object, etc).

A processor 24 including image analyzing software 26 obtains the frames stored in the image memory 22 and uses the software 26 to perform a frame-by-frame intensity variance analysis of each pixel of the collected frames. The analysis produces a well defined image of the object being detected. In one example, to be discussed further in the following paragraphs, the object is presented as a silhouette in a final image, which in one example is a black and white image. The final image may be displayed on a suitable display 28.

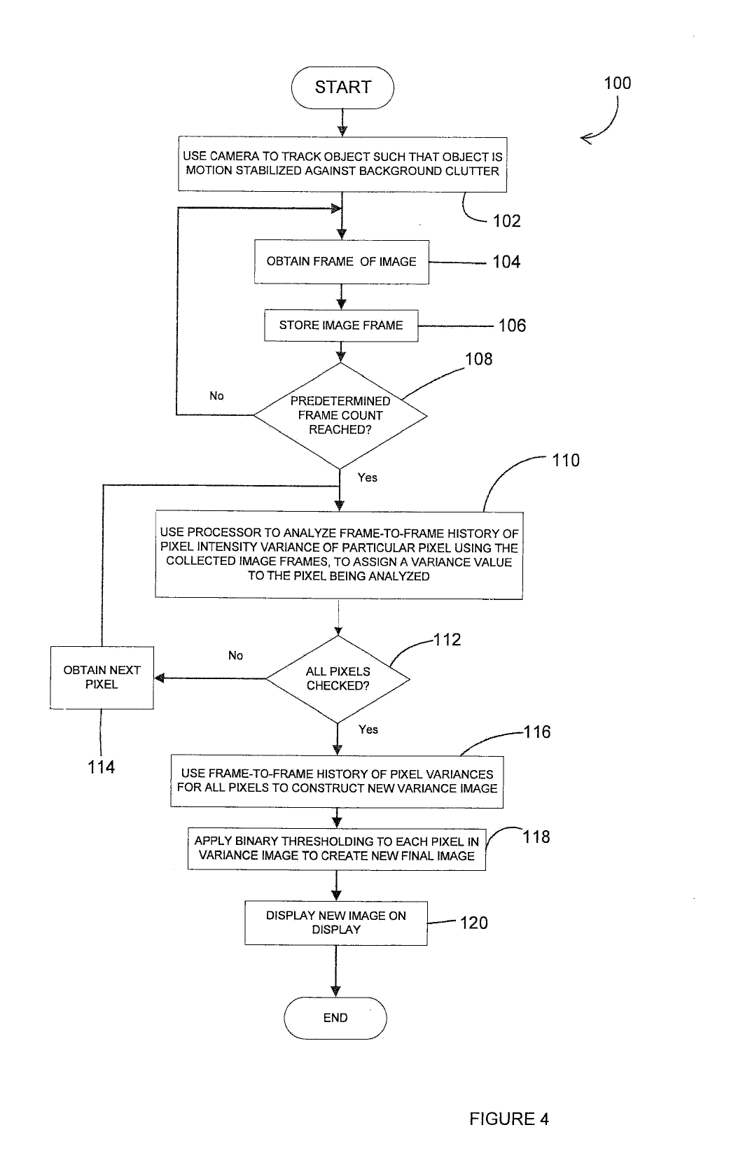

Referring to FIG. 4, a flowchart 100 is illustrated setting forth a plurality of operations for one exemplary implementation of a method of the present disclosure. At operation 102 the camera 12 is used to track the object 16 so that the object is motion stabilized against the background clutter within the field of view 14. At operation 104 the camera 12 obtains an image frame of the field of view. At operation 106 the just-obtained image frame is stored in the image memory 22. At operation the 108 a check is made to determine if the predetermined frame count for filling the image frame buffer history has been satisfied yet. If not, a loop is made back to re-perform operations 104-108.

If the answer to the inquiry made at operation 108 is “Yes”, then the processor 24 begins the process of analyzing the frame-to-frame history of pixel intensity variance of each pixel within the captured image frames, as indicated at operation 110. More specifically, at operation 110 the processor examines a first pixel at a first pixel location of the image frames to determine the degree to which the first pixel varies from frame to frame, once all of the collected images frames have been examined. The processor uses the image analyzing software 26 to perform this function. Typically, for background clutter, there will be a significant intensity variance for a given pixel, when examining the given pixel over a plurality of successively taken image frames. The opposite will typically be true for pixels that are being used to make up the object. Typically the pixels making up the object will vary only slightly, or not at all, in intensity when examining a series of successively taken image frames taken over a given time period. The processor 24 uses the software 26 to assign an intensity variance value for the pixel being examined. The pixel intensity variance value thus represents the magnitude by which that particular pixel has changed in intensity in the collected image frames.

At operation 112, a check is made to determine if all the pixels in the collected image frames have been examined. If not, then the pixel at the next pixel location is obtained, as indicated at operation 114, and operations 110 and 112 are repeated for the newly obtained pixel. When all of the pixels from the collected image frames have been examined, the processor 26 will have assigned a pixel intensity variance value to every single pixel that makes up the collected image frames. The pixel intensity variance value essentially is a digital value that represents an intensity variance of its associated pixel that is obtained from analyzing the complete collection of image frames obtained from the image memory 22.

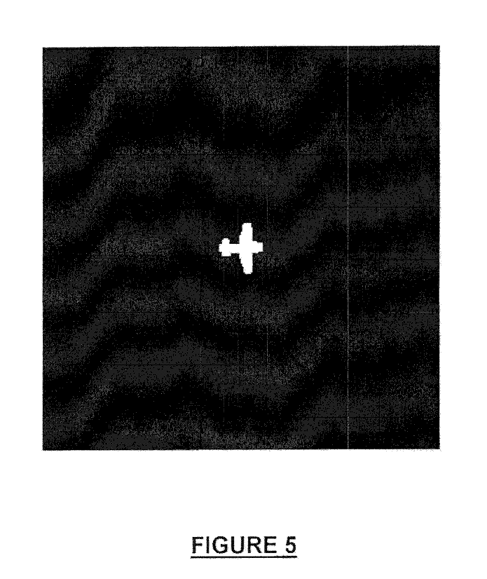

When the check at operation 112 produces a “Yes” answer, then the processor 24 uses the just created frame-to-frame history of pixel intensity variances to construct a new pixel intensity variance image, as indicated at operation 116. This image uses all of the pixel intensity variance values created at operation 110 to form an image that allows a binary intensity comparison to be made against each pixel. At operation 118, a binary threshold test is then applied to each pixel intensity variance value in the variance image created at operation 116. This involves using a predetermined threshold intensity variance value, which is preferably a low variance value representing only a small variation in pixel intensity (e.g., possibly 10% to 50% of the average clutter pixel value), and comparing each of the created pixel intensity variance values from the variance image 116 against the predetermined threshold intensity variance value. In this manner, it can be assured that only pixels that have only small, or virtually no, intensity variance will be identified as object-related pixels. This series of binary threshold tests produces either a logic “1” or a logic “0” answer for each pixel variance value checked, depending upon whether a given pixel intensity variance value exceeds the predetermined threshold intensity variance value. For example, if a test of a specific pixel intensity variance value results in a logic “1” answer, that may indicate that the variance value exceeds the predetermined threshold intensity variance value, and is therefore determined to be associated with a pixel that is representing background clutter. Conversely, if the test produces a logic “0” answer, then it may be understood that pixel intensity variance value is representing a pixel that is associated with the object. The results of the binary tests performed at operation 118 may be used to create a new “final” image. The final image, for example, may be a black and white image within which a silhouette of the object is presented. An example of such an image is shown in FIG. 5. The final image may then be displayed on the display 28 of the system 10, as indicated at operation 120.

The black and white image presented in FIG. 5 is but one exemplary way in which the object 16 may be presented in a manner that makes its profile or silhouette clear. Other color schemes could be employed as well. In any event the profile of the object 16 is immediately apparent because of the lack of confusing background clutter that would ordinarily tend to obscure a portion, or possibly all, of the object.

The system 10 and the method described herein avoids the complexities that are faced when attempting to optically discern an object from a cluttered background by analyzing pixel intensities in a single frame of a field of view. By using the temporal variance in intensity of pixels from a succession of frames, taken over a desired time period, an image can be constructed that clearly defines the object of interest within the field of view.

Various image detection/enhancing methodologies may also be used to further enhance the basic methodology described herein. Such methodologies are presented below:

Spatial Background Variance

This methodology involves computing spatial variance within one single image frame for various regions of the image frame to determine if the image scene is highly cluttered or not. It may be desirable to analyze non-cluttered scenes with a conventional thresholding approach or to find out if a tracked object is leaving/entering a cluttered environment. An example would be if a tracked aircraft was flying in and out of a bland background environment, such as fog or haze.

Computation of Bounding Boxes

This methodology may be used to define a region (that may be termed a “bounding box”) externally of, but close to, a tracked object in the visual field of view. This is also useful to see if the object is entering a different environment with respect to clutter (e.g., a virtually uncluttered region of the field of view), or to exclude all areas outside of the bounding box as possible detection areas. This might help to eliminate the possibility of false positive detections for various pixels and to reduce processor 24 computation time by limiting detailed pixel analysis to only small sub-regions of the field of view where background clutter is known to be present.

Temporal Variance Analysis

This methodology looks at the temporal variance in intensity for the whole scene (i.e., the entire field of view), as opposed to discrete pixel-by-pixel determinations for the entire scene. More specifically, this methodology can be used for examining the cluttered and tracked object areas separately as an aid for on-the-fly computation of dynamic intensity thresholds. This may be useful in scenes where the properties of the clutter change dramatically. For example, if an aircraft being tracked from above against an urban background were to then enter a desert environment, the amount of variance in the background would be expected to reduce significantly. This information would then allow the tracking software to optimize the binary threshold even more effectively for the new environment.

Temporal Binary Filtering

This methodology involves creating a plurality of the final images using the binary thresholding tests, from a large collection of saved image frames, and saving the last n final images. To filter out transient false detections, a certain subset of the final images having equal time spacing of the n images (i.e., taken at set time intervals, for example every five seconds) are examined pixel-by-pixel. For a detection to be present for a given pixel, it must be present at or above a certain percentage of the subset of frames analyzed. This may be effective in cases where the tracked object traverses occasionally over portions of background which vary only slightly in intensity, and which therefore might be evaluated by the processor 24 as detections (i.e., as “false positive” detections). The sampling rate for prior image frames obtained by the camera 12 is dependent upon the period of passing of these low-variance regions of the image.

Hole Filling

Some objects being tracked may have areas of high intensity variance (such as blinking lights) internal to the object itself. After processing by the processor 24, these areas may show up on the final image as spots of missed detections (i.e., they may be spots erroneously detected as background clutter). Various well known hole-filling algorithms may be used to fill these regions in for subsequent analysis, if necessary. One suitable, commercially available software solution that provides hole-filling algorithms is MATLAB®, available from The Mathworks, Inc., of Natick, Mass.

While various embodiments and methods have been described, those skilled in the art will recognize modifications or variations which might be made without departing from the present disclosure. The examples illustrating the various embodiments and methodologies are not intended to limit the present disclosure. Therefore, the description and claims should be interpreted liberally with only such limitation as is necessary in view of the pertinent prior art.

1. A method for optically detecting an object within a field of view, where the field of view contains background clutter tending to obscure visibility of the object, the method comprising:
optically tracking said object such that said object is motion stabilized against said background clutter;
during said optical tracking, obtaining a plurality of frames of said field of view;
using said plurality of frames to perform a frame-to-frame analysis of variances in intensities of pixels within said frames; and
using said variances in intensities to discern said object.

2. The method of claim 1, wherein optically tracking said object such that said object is motion stabilized comprises using a camera and panning said camera in accordance with motion of said object.

3. The method of claim 1, wherein using said plurality of frames to perform a frame-to-frame analysis of variances in intensities of pixels comprises:
using said variances in intensities of said pixels to construct a variance image;
comparing each pixel of said variance image to a threshold intensity value; and
using the results said comparisons of each said pixel to said threshold intensity value to construct a final image of said object.

4. The method of claim 3, wherein constructing a final image of said object comprises constructing a black and white image of said object within said field of view.

5. The method of claim 1, wherein obtaining a plurality of frames of said field of view comprises obtaining a predetermined plurality of frames.

6. The method of claim 1, further comprising:
for at least one region within one said frame, determining a spatial variance of pixels within said one region to preliminarily determine if said field of view contains background clutter.

7. The method of claim 1, further comprising defining a sub-region within said field of view closely adjacent, but external to, said object; and
performing an analysis of pixel intensity variance within said sub-region to determine if said sub-region includes background clutter.

8. The method of claim 3, further comprising:
using said method to repeatedly create a plurality of final images of said object.

9. The method of claim 8, further comprising:
saving a predetermined number of said final images;
examining, pixel-by-pixel, a subset of said predetermined number of saved final images; and
only concluding that a particular pixel is detected when said particular pixel is detected at or above a predetermined percentage of times for the subset of final images examined.

10. A method for optically detecting an object within a field of view, where the field of view contains background clutter tending to obscure visibility of the object, the method comprising:
optically tracking said object such that said object is motion stabilized against said background clutter;
during said optical tracking, obtaining a plurality of frames of said field of view;
using said plurality of frames to perform a frame-to-frame analysis of variances in intensities of pixels within said frames;
using said variances in intensities of said pixels to construct a pixel intensity variance image represented by pixel intensity variance values for each said pixel;
applying a binary threshold test to each said pixel intensity variance value to determine if each said pixel intensity variance value exceeds a predetermined intensity variance threshold level; and
using the results of said binary threshold test to construct a final image of said object.

11. The method of claim 10, wherein optically tracking said object such that said object is motion stabilized comprises using a camera and panning said camera in accordance with motion of said object.

12. The method of claim 10, wherein using the results of said binary threshold test to construct a final image comprises using the results to construct a black and white image within which said object is present.

13. The method of claim 10, further comprising displaying said final image on a display.

14. The method of claim 10, further comprising:
using a memory to function as a buffer to store said frames; and
using a processor to perform said frame-to-frame variance of intensities of said pixels.

15. The method of claim 10, wherein obtaining a plurality of frames of said field of view comprises obtaining a predetermined plurality of said frames.

16. The method of claim 10, further comprising:
using said method to repeatedly create a plurality of final images of said object.

17. The method of claim 16, further comprising:
saving a predetermined number of said final images;
examining, pixel-by-pixel, a subset of said predetermined number of saved final images; and
only concluding that a particular pixel is detected when said particular pixel is detected at or above a predetermined percentage of times for the subset of final images being examined.

18. The method of claim 10, further comprising analyzing said final image to determine if one or more areas of said object appear to be represented by a pixel that has been incorrectly identified as representing background clutter, and using a hole filling algorithm in a subsequent operation to fill in any pixel within said object that is determined to be erroneously representing background clutter.

19. The method of claim 10, further comprising:
for at least one region within one said frame, determining a spatial variance of pixels within said one region to preliminarily determine if said field of view contains background clutter.

20. A system for optically detecting an object within a field of view, where the field of view contains background clutter tending to obscure visibility of the object, the system comprising:
a camera for optically tracking said object such that said object is motion stabilized against said background clutter, the camera obtaining a plurality of frames of said field of view;
a processor that uses said plurality of frames to perform a frame-to-frame analysis of variances in intensities of pixels within said frames, said processor being operable to use said variances in intensities of said pixels to construct a pixel intensity variance image represented by pixel intensity variance values for each said pixel;
said processor adapted to apply a binary threshold test to each said pixel intensity variance value to determine if each said pixel intensity variance value exceeds a predetermined intensity variance threshold level, and to use the results of said binary threshold test to construct a final image within which said object is present; and
a display for displaying said final image.
